(19) United States
(12) Patent Application Publication
(10) Pub. No.: US 2026/0094341 A1
(43) Pub. Date: Apr. 2, 2026

(54) Viewer Motion Compensation

(71) Applicant: Apple Inc., Cupertino, CA (US)

(72) Inventors: James A. McCombe, San Francisco, CA (US); Alan M. Moss, Laguna Beach, CA (US); Matthew J. Yaeger, Tustin, CA (US)

(21) Appl. No.: 19/342,408

(22) Filed: Sep. 26, 2025

Related U.S. Application Data
(60) Provisional application No. 63/700,514, filed on Sep. 27, 2024.

(51) Int. Cl. G06T 15/00; G06F 3/01

(52) U.S. Cl. CPC G06T 15/00; G06F 3/012; G06F 3/013

(57) ABSTRACT

Scene depth parameters are adjusted based on user motion. Scene data is obtained for a 3D scene having image data and depth data. User motion parameters are also obtained. User motion includes head movement or rotation, gaze direction, or some combination thereof. When the user motion parameters satisfy a treatment threshold, the depth data for the scene is adjusted based on the user motion, and the image of the 3D scene is rendered. The adjusted scene depth includes a reduced depth variance, target scene depth, or the like. The amount of adjustment corresponds to an amount of user motion.

### BACKGROUND

Immersive videos, such as 360-degree video or other video that substantially occupies the user's field of view, provide enhanced possibilities for user experience. These immersive videos allow viewers to more fully explore a scene. Immersive videos are often captured on specialized cameras which capture a scene with wide field of view or from multiple viewpoints.

Immersive video technologies, such as those used in virtual reality (VR) and augmented reality (AR) systems, often face challenges in accurately rendering 3D scenes when users move their heads. Traditional systems typically assume a fixed point of view, which can lead to discomfort and visual artifacts when the user rotates their head around the neck joint rather than the eyes. This discrepancy becomes particularly noticeable for objects that are close to the viewer, as the content appears to move incorrectly with head rotation.

### BRIEF DESCRIPTION OF THE DRAWINGS

FIGS. 1A-1B depict example diagrams of a typical immersive media item viewed from different angles, in accordance with one or more embodiments.

FIG. 2 depicts a flowchart of a technique for adjusting scene depth based on user motion parameters, in accordance with one or more embodiments.

FIG. 3 shows an example diagram of an adjusted scene depth based on user motion, in accordance with one or more embodiments.

FIG. 4 shows a flowchart of an example technique for determining user motion parameters, in accordance with one or more embodiments.

FIG. 5 shows a flowchart of an example technique for adjusting scene depth, in accordance with one or more embodiments.

FIG. 6 provides an example diagram of a reduced scene depth variance based on user motion, in accordance with one or more embodiments.

FIG. 7 shows a flowchart of an alternate technique for adjusting scene depth by identifying a target depth value corresponding to the gaze target, in accordance with one or more embodiments.

FIG. 8 illustrates an example diagram for modifying compressed depth based on user motion, in accordance with one or more embodiments.

FIG. 9 shows a flowchart of an example technique for rendering the scene based on image data and scene depth, in accordance with one or more embodiments.

FIG. 9 is a data flow diagram for rendering a 3D scene, in accordance with one or more embodiments.

FIG. 10 illustrates an example diagram for modifying compressed depth based on user motion, in accordance with one or more embodiments.

FIG. 11 provides an alternate example diagram for dynamically modifying a scene depth based on a gaze target, in accordance with one or more embodiments.

FIG. 12 depicts a flowchart of a technique for dynamically modifying rendering depth based on gaze, in accordance with one or more embodiments.

FIG. 13 depicts an example system configured to present immersive content, in accordance with one or more embodiments.

FIG. 14 depicts a system diagram of an electronic device on which embodiments described herein may be performed.

### DETAILED DESCRIPTION

The present disclosure generally relates to immersive video technologies, and specifically to methods and systems for viewer motion compensation for immersive media rendering. Embodiments described herein address the challenges associated with rendering 3D scenes based on user head movement and gaze direction, particularly for close objects, to enhance visual fidelity and minimize artifacts.

When immersive media is captured, such as with 360-degree video or 3D content, cameras typically capture the scene using stereo cameras intended to reflect the stereo view of a viewer's eyeballs. However, when a viewer turns their head, the eyeballs do not merely rotate around a point, but they also move along a translation that occurs due to the fact that the eyeballs sit in front of the neck joint around which the head pivots. As a result, the stereo capture of a scene may not accurately reflect the view of a person's eyes when the person rotates their head. Artifacts are especially apparent in objects closest to the user. Techniques described herein provide solutions to reduce the appearance of artifacts due to the offset of the eyes from the neck causing the translation.

Some embodiments described herein reduce the artifacts by introducing dynamic depth compression. Typically, a 3-D media item will consist of a scene geometry, such as depth or disparity values, or a geometric representation such as a mesh or point cloud, along with image data to be overlaid on top of the scene geometry. The captured scene depth may be associated with an original scene depth variance. In some embodiments, the scene geometry is dynamically compressed based on gaze such that when the head is more stationary or moving more slowly, the scene is presented with compressed depth (i.e., a reduced scene depth variance), thereby reducing the appearance of artifacts when the image data is overlaid on the geometry. By contrast, if the head is moving quickly, the scene geometry may be expanded out to more closely reflect the actual scene geometry. Because the head is in motion, the artifacts would be less apparent to the user. In some embodiments, gaze is also considered such that if the head moves but the gaze stays consistent, the scene geometry may remain compressed.

Additionally, or alternatively, certain embodiments described herein are directed to using a reduced scene depth variance despite a velocity of the user motion, and projecting the scene geometry having the reduced scene variance at a depth consistent with a depth in the original scene depth at the gaze target. In doing so, the point at which the viewer is looking will be presented at a true depth corresponding to the captured scene geometry, but the geometry of the scene surrounding the viewpoint will be adjusted based on the reduced scene variance. Thus, the depth at which the adjusted scene geometry is presented will be dynamically modified based on the adjusted scene geometry and an original depth in the scene corresponding to a gaze target.

In addition, certain embodiments described herein are directed to using a rendering depth for the image data based on a gaze target compared to the captured scene geometry, but projecting the image on a single depth value. Accordingly, the image data will appear at the correct depth at the gaze target in the scene, but the image around the gaze target will be rendered at an incorrect depth, but is less noticeable to the user.

Techniques described herein provide numerous technical benefits. For example, by adjusting the depth variance for the scene, depth conflict can be reduced or avoided for near objects. Further, techniques described herein provide a technical benefit to overcome challenges in presenting captured 3D content in a manner which comports to a viewing experience. Accordingly, techniques described herein are additionally directed to a novel image processing technique for 3D content.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed concepts. In the interest of clarity, not all features of an actual implementation may be described. Further, as part of this description, some of this disclosure's drawings may be provided in the form of flowcharts. The boxes in any particular flowchart may be presented in a particular order. It should be understood, however, that the particular sequence of any given flowchart is used only to exemplify one embodiment. In other embodiments, any of the various elements depicted in the flowchart may be deleted, or the illustrated sequence of operations may be performed in a different order, or even concurrently. In addition, other embodiments may include additional steps not depicted as part of the flowchart. Moreover, the language used in this disclosure has been principally selected for readability and instructional purposes and may not have been selected to delineate or circumscribe the inventive subject matter, it being necessary to resort to the claims in order to determine such inventive subject matter. Reference in this disclosure to “one embodiment” or to “an embodiment” means that a particular feature, structure, or characteristic described in connection with the embodiment is included in at least one embodiment of the disclosed subject matter, and multiple references to “one embodiment” or “an embodiment” should not necessarily be understood as all referring to the same embodiment.

It will be appreciated that, in the development of any actual implementation (as in any software and/or hardware development project), numerous decisions must be made to achieve a developer's specific goals (e.g., compliance with system-and business-related constraints) and that these goals may vary from one implementation to another. It will also be appreciated that such development efforts might be complex and time consuming but would nevertheless be a routine undertaking for those of ordinary skill in the design and implementation of multi-modal processing systems having the benefit of this disclosure.

Various examples of electronic systems and techniques for using such systems in relation to various technologies are described.

A physical environment, as used herein, refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust the characteristic(s) of graphical content in the XR environment in response to representations of physical motions (e.g., vocal commands).

There are many different types of electronic systems that enable a person to sense and/or interact with various XR environments. Examples include: head-mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). The head-mountable system may incorporate one or more imaging sensors to capture images or video of the physical environment and/or one or more microphones to capture audio of the physical environment. Rather than an opaque display, a head-mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

### Traditional Techniques

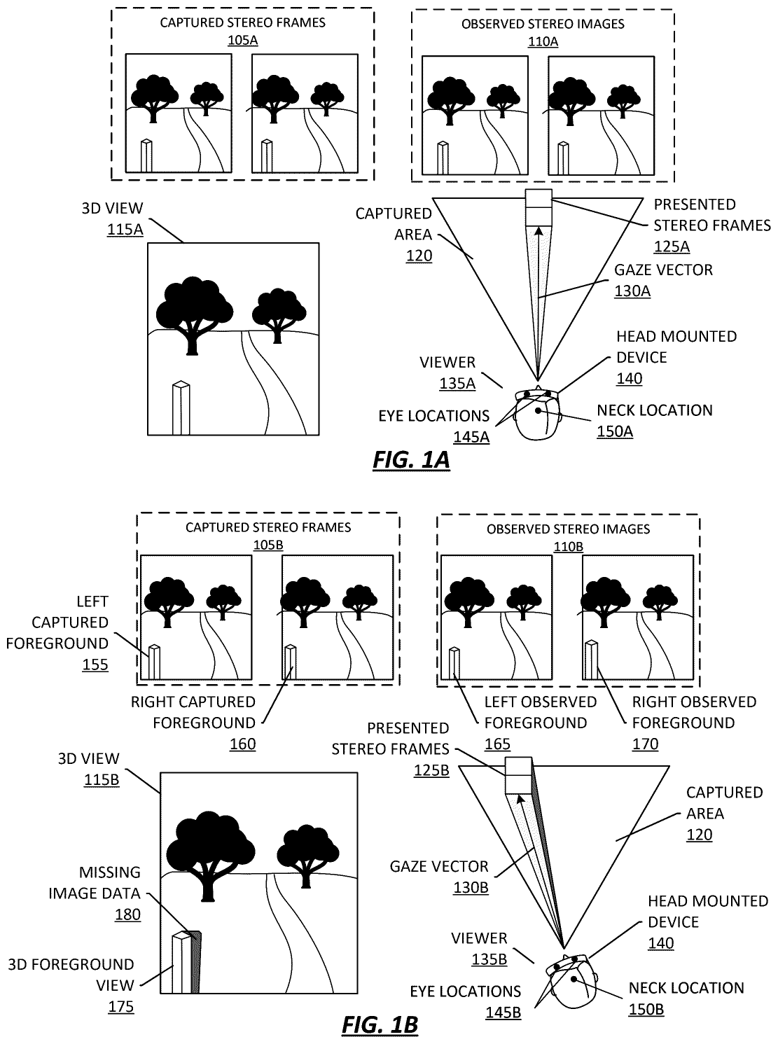

FIGS. 1A-1B depict example diagrams of a typical immersive media item viewed from different angles, in accordance with one or more embodiments. In particular, FIG. 1A shows an example diagram of a user looking into a scene at a same view as the scene was captured. By contrast, FIG. 1B depicts an example diagram of a technique of a disconnect between captured 3D image data and a viewer's experience of the 3D scene due to artifacts arising from the user motion. It should be understood that the particular depth and image data are presented and explained for example purposes, and are not intended to limit the embodiments described herein.

In the diagram of FIG. 1, captured stereo frames 105A are compared against observed stereo images 110A. In particular, captured stereo frames 105A show stereo images as captured by a stereo camera for an immersive media experience. Viewer 135A views the presented stereo frames 125A by gaze vector 130A, which matches the captured view of captured stereo frames 105A. In particular, the eye locations 145A are aligned with the stereo camera device capturing the captured area 120. Accordingly, although eye locations 145A are offset from neck location 150A, the resulting 3D view 115A does not show any artifacts.

By contrast, turning to FIG. 1B, when the user's eyes no longer align with the stereo camera system capturing the scene, then artifacts arise. For example, captured stereo frames 105B are captured from a straight-ahead view of the environment. Thus, left captured foreground 155 and right captured foreground 160 appear to be in similar size to each other. This may occur because the left and right stereo cameras are parallel to the captured scene. However, because the user is looking at the scene from an angle, the observed stereo image does not match the captured stereo image. This is shown by viewer 135B viewing the presented stereo frame is 125B at an angle. In particular, the viewer 135B has rotated their head around neck location 150B, thereby causing the eye locations 145B to not only rotate, but become slightly offset along a translation. That is, whereas the stereo camera system capturing the captured stereo frames 105B are parallel to the scene, the eye locations 145B are not parallel to the scene. Rather, the right eye is closer to the scene in the left eye. As a result, observed stereo images 110B provide a representation of how the scene would look to the viewer. Thus, left observed foreground 165 appears smaller than right observed foreground 170 due to the left eye being further away from the scene than the right eye.

A result of the gaze vector 130B is that the viewer views the presented stereo frames 125 in a manner such that some of the image data is missing. This is apparent when considering 3D view 115B, which shows that the 3D view in the stereo images viewed by the viewer's eyes through head mounted device 140 shows the foreground view 175 adjacent to missing image data 180. That is, because the right eye has not only rotated but moved to a new location along a translation, the viewer 135B is attempting to look around the 3D foreground view 175, but that portion of the scene was not captured in captured stereo frame is 105B. Embodiments described below address this missing image data 180 in a variety of ways.

### Adjusting Scene Depth Based on User Motion

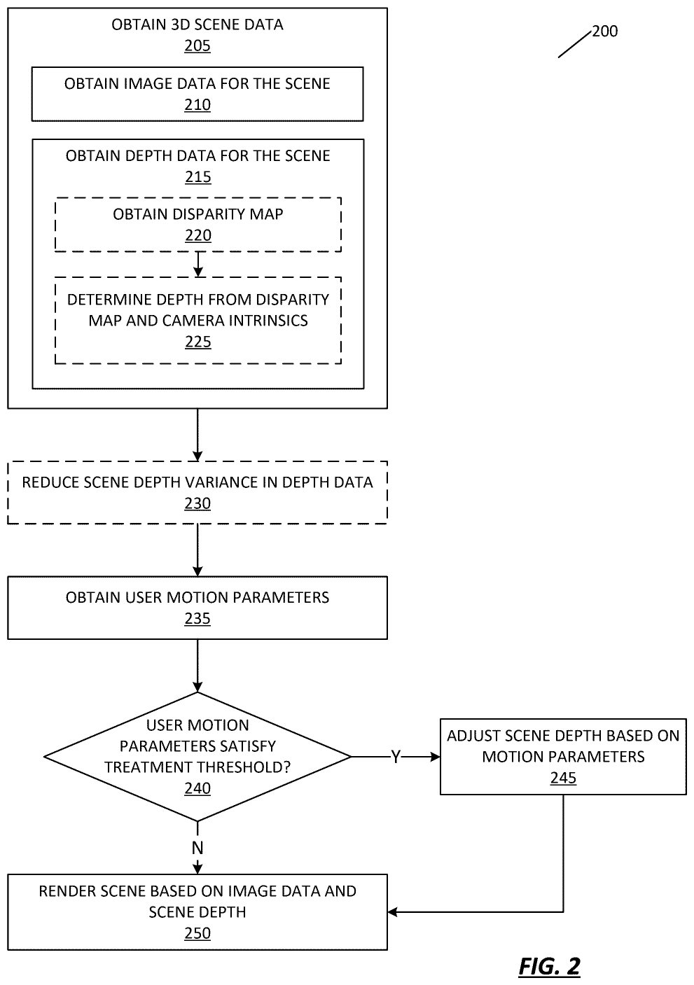

FIG. 2 shows a flowchart of a technique for reducing artifacts due to user motion, in accordance with one or more embodiments. For purposes of explanation, the following steps will be described in the context of particular components. However, it should be understood that the various actions may be taken by alternate components. In addition, the various actions may be performed in a different order. Further, some actions may be performed simultaneously, and some may not be required, or others may be added, according to various embodiments.

The flowchart 200 begins at block 205, obtaining scene data for a 3D scene. The 3D scene data may be obtained from a network device or remote service, such as a media distribution platform, or may be stored locally on a playback device. According to one or more embodiments, obtaining scene data may include obtaining image data for the scene at block 210, and obtaining depth data for the scene, as shown at block 215. According to some embodiments, the image data and depth data may be obtained from one or more remote devices over a network. The image data and depth data may be obtained locally at a device configured to present 3D content, such as a head mounted device or other wearable or mobile device. In some embodiments, the image data may be an RGB image or RGBD image. Alternatively, the scene data may be in the form of RGBD data.

According to some embodiments, the depth data for the scene obtained at block 215 may be determined from disparity in the stereo images. That is, if the 3D content is provided in the form of stereo images, the disparity across stereo frames may be used to determine depth in the scene. Thus, an optional step 220, obtaining depth data for the scene may include obtaining a disparity map for the 3D scene data. The disparity map is generated by comparing the left and right images captured by the stereo cameras. Each value in the disparity map represents the horizontal shift (disparity) between corresponding points in the left and right images, where a larger value indicates a closer object to the camera. At block 225, depth of the scene is determined from the disparity map and camera intrinsics. In particular, calibration parameters specific to the camera or cameras that captured the scene are used to determine depth. This may include, for example, focal length, principal point, lens distortion coefficients, and the like. The camera calibration parameters may be used to correct for distortions in the captured images so that the depth is accurately mapped. Depth is determined for the scene using a combination of the focal length of the camera, baseline distance of the two cameras, and the disparity value. In some embodiments, a depth map can be constructed from the depth values, and/or a geometry of the scene can be generated, such as a mesh or a point cloud representing a geometry of the scene.

The depth map and/or resulting geometry may be associated with an original scene depth variance, indicating a difference in the closest and farthest point in the scene geometry. At optional block 230, the scene depth variance may be reduced in the original depth map and/or resulting geometry such that the range of depth of the scene is reduced. Some embodiments described herein use a reduced scene depth variance to reduce the appearance of artifacts in the 3D scene. The amount the scene depth variance may be compressed may be a constant value or may be dynamically determined. In some embodiments the amount of compression applied to the scene depth may be based on characteristics of the scene, user characteristics, device characteristics, or the like.

The flowchart 200 proceeds to block 235, where user motion parameters are obtained indicating characteristic of user motion. User motion parameters may include information or measurements related to head movement and/or gaze direction. In some embodiments, the user motion parameters may be determined based on sensor data collected from the local device. For example, user-facing sensors on an HMD may track a gaze direction of the user. In addition, orientation sensors in the HMD such as gyroscopes, accelerometers, magnetometers, and the like, may track a head position and/or motion. Motion parameters may include direction and/or velocity at any particular time, or over time.

The flowchart proceeds to block 240 where a determination is made as to whether the user motion parameters satisfy a treatment threshold. The user motion parameters may indicate that the characteristics of the position and/or motion of the user (such as head motion or position, gaze direction, or the like) are such that scene depth should be modified to reduce artifacts. Thus, if the user motion parameters satisfy a treatment threshold, then the flowchart 200 proceeds to block 245, and the scene depth is adjusted based on the motion parameters. In some embodiments, the depth variance of the scene is modified in accordance with a velocity of the head and/or the gaze target. In some embodiments, the rendering depth of the scene may be adjusted based on gaze and is the variance is always used, such as when the scene depth variance is reduced at block 230.

The flow chart concludes at block 250, where the scene is rendered based on the image data and the scene depth as adjusted at block 245. Returning to block 240, if the user motion parameters do not satisfy the treatment threshold, then the flowchart concludes at block 250 and the original scene depth (or reduced scene depth from optional block 230) are used to render the scene. For example, the image data obtained at block 210 may be applied to the scene geometry based on the original or adjusted depth information for the scene.

### Dynamic Scene Depth Variance

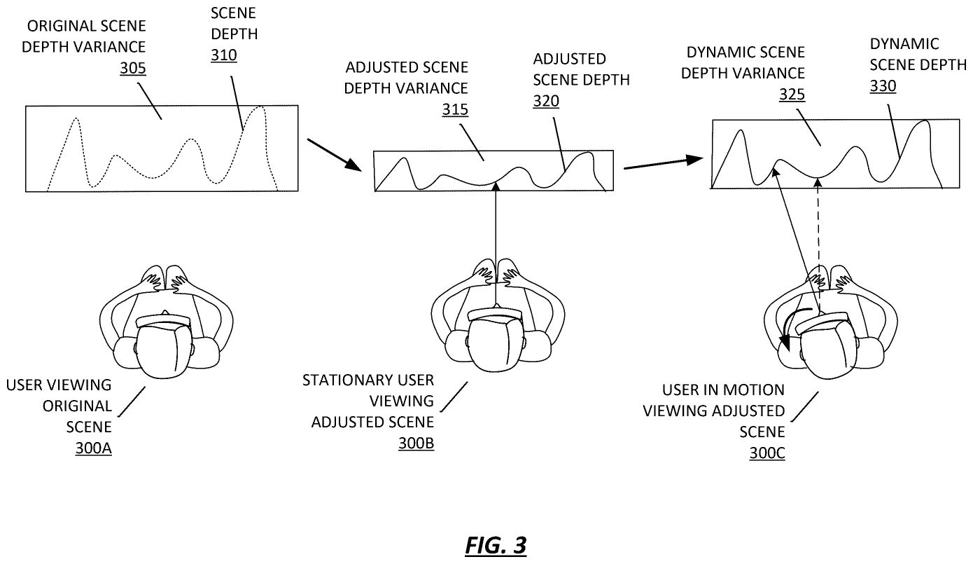

According to some embodiments, the amount of compression applied to the scene depth may be adjusted during playback of the 3D media item based on a current motion of the user. FIG. 3 shows an example diagram of an adjusted scene depth based on user motion, in accordance with one or more embodiments. In particular, FIG. 3 shows a representation of a user viewing an original scene 300A with a scene depth 310 having an original scene depth variance 305. For purpose of this example, the setup is shown for example purposes without applying an adjusted scene depth.

By contrast, in some embodiments, the scene depth may be adjusted dynamically based on user motion. Because artifacts may be more apparent when a user is still or moving slowly, the scene depth may be more compressed when less user motion is detected. Thus, a stationary user viewing an adjusted scene 300B may view the scene having an adjusted scene depth 320 with an adjusted scene depth variance 315.

When the user's head moves, such as user in motion viewing adjusted scene 300C, the dynamic scene depth variance 325 and dynamic scene depth 330 may be adjusted to be closer to the original scene depth 310 and/or original scene depth variance 305. Thus, as the user is in motion from the head rotation, the depth of the scene is presented closer to the true scene depth. The user will see the resulting scene closer to the true scene depth when the artifacts resulting from the true scene depth are less apparent.

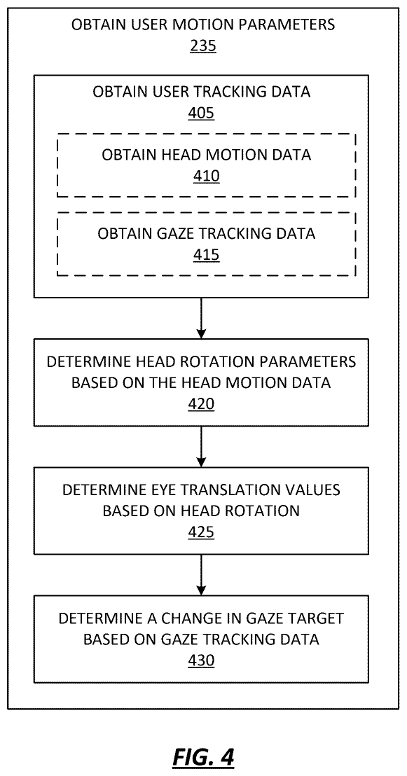

FIG. 4 shows a flowchart of an example technique for determining user motion parameters, in accordance with one or more embodiments. In particular, FIG. 4 shows a more detailed example of how user motion parameters are obtained, for example as described above with respect to block 235 of FIG. 2. For purposes of explanation, the following steps will be described in the context of particular components. However, it should be understood that the various actions may be taken by alternate components. In addition, the various actions may be performed in a different order. Further, some actions may be performed simultaneously, and some may not be required, or others may be added, according to various embodiments.

The flowchart begins at block 405, where user tracking data is obtained. According to one or more embodiments, user tracking data may include position information, location information and the like for the user. Optionally, as shown at block 410, head motion data may be obtained. Head motion data may include a current position or direction of a user's head. In some embodiments, the head motion data may additionally include velocity information for motion of the head at a particular time. According to one or mor embodiments, the head motion data may correspond to position and/or orientation and/or motion of a playback device presenting 3D media being worn by a viewer. According to one or more embodiments, the head pose data may be captured or derived from sensor data collected by one or more positional sensors, such as an inertial measurement unit (IMU), gyroscope, magnetometer, accelerometer, and/or other orientation sensor as part of the HMD.

Obtaining user tracking data 405 may also include, at block 415, obtaining gaze tracking data. According to embodiments, gaze tracking data may be obtained from one or more user-facing sensors of an HMD configured to collect information about a user's eyes. For example, an orientation of the eyes may be determined based on sensor data capturing the eyes viewing the HMD. The orientation of the eyes may be used to determine characteristics regarding the gaze. In some embodiments, a gaze vector may be projected out from the eye through the pupil into the immersive media to determine a gaze target. A change in the gaze target due to the movement of the eyes may be determined, such as a rate of change of the gaze.

The flow chart continues at block 420, where head rotation parameters are determined based on the head motion data. The head rotation parameters may include values or information regarding a speed, direction, magnitude, or the like of a change in head position based on a head movement. In some embodiments, the rotation parameters may include values for the roll, pitch, and yaw of the head rotation.

At block 425, eye translational values are determined based on the head rotation. In some embodiments, a position of the eyes may be predefined with respect to the user's head or other features, such as a neck joint. By applying the rotation parameters to the eye locations, a determination can be made as to a translational value of the movement of the eyes. That is, by tracking not only the movement of the eyes due to rotation, but also the translational values due to the placement on the head, the actual motion of the eyes is better tracked.

The flowchart concludes at block 430, where a change in gaze target is determined based on the gaze tracking data. A change in the gaze target due to the movement of the eyes may be determined, such as a rate of change of the gaze. This may indicate, for example, whether the user is moving their head but maintaining a steady gaze, or if the gaze is moving along with the head.

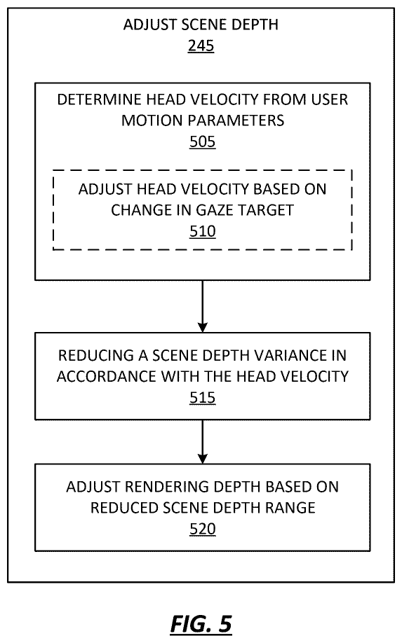

The various user motion parameters can be used to dynamically adjust the scene depth, in accordance with one or more embodiments, as described above with respect to block 245 of FIG. 2. FIG. 5 shows a flowchart of an example technique for adjusting scene depth, in accordance with one or more embodiments. For purposes of explanation, the following steps will be described in the context of FIG. 3. However, it should be understood that the various actions may be taken by alternate components. In addition, the various actions may be performed in a different order. Further, some actions may be performed simultaneously, and some may not be required, or others may be added, according to various embodiments.

The flow chart begins at block 505, where a head velocity is determined from the motion parameters. The head velocity may indicate an angular velocity of the head due to a head rotation. The head velocity may be determined, for example, by determining head pose information for a series of frames to determine a rate of change any head pose due to the rotation. Referencing back to FIG. 3, the head velocity may be determined based on the change in head position from the stationary user viewing adjusted scene 300B to the user in motion viewing the adjusted scene 300C.

Optionally, as shown at block 510, the head velocity may be adjusted based on a change in gaze target. For example, although a head rotation may indicate a change in a gaze target, if the user maintains focus on the particular point in the scene while the head is rotated, the fact that the user maintains the gaze target may adjust the value used for the head velocity. For example, the head velocity may be adjusted to better capture a rate of change of the gaze target, or the like.

The flow chart proceeds to block 515, where a scene depth variance is reduced in accordance with the head velocity. In some embodiments, an amount of compression applied to the seeing that variance may correspond, directly or indirectly, to the change in head velocity (and/or rate of change of the gaze). Accordingly, a set of adjusted depth values may be determined for the scene based on the reduction. In some embodiments, the reduction may occur around a median depth, a depth of a point of interest in the scene, or the like. For example, returning to FIG. 3, the adjusted scene depth 320 has an adjusted scene depth variance 315 which is compressed from the original scene variance 305 as the user is still. By contrast, the dynamic scene depth 330 has an adjusted scene depth variance 325 which is close to the original scene depth variance 305 based on motion of the user.

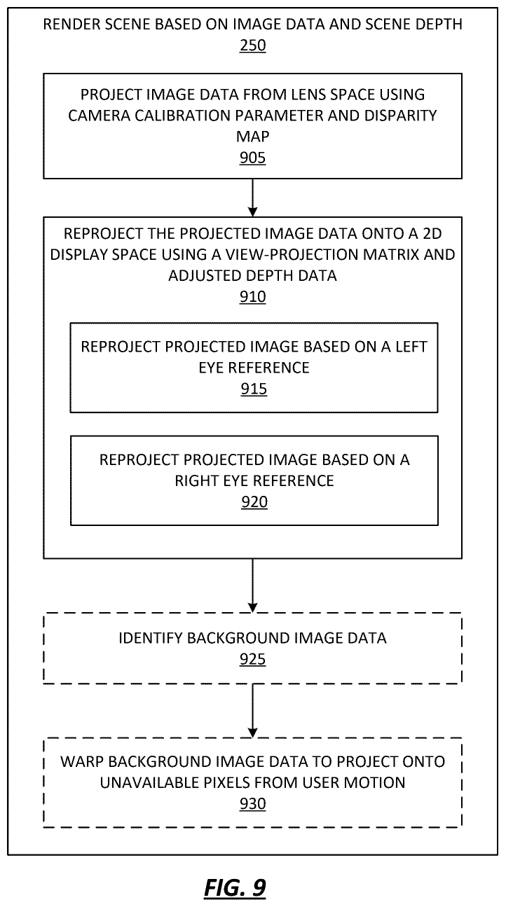

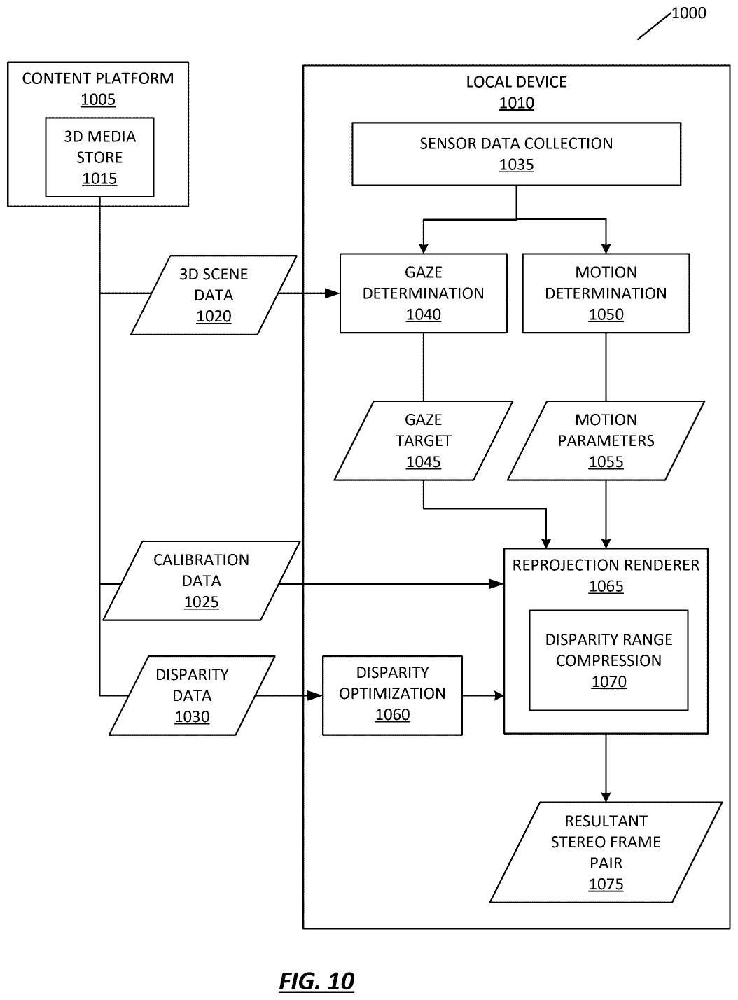

The flowchart concludes at block 520, where a rendering depth is adjusted based on the reduced scene depth variance. For example, the adjusted or dynamic scene depth may be used to apply image data for the scene during rendering of the scene, as will be described in greater detail below with respect to FIGS. 9-10.

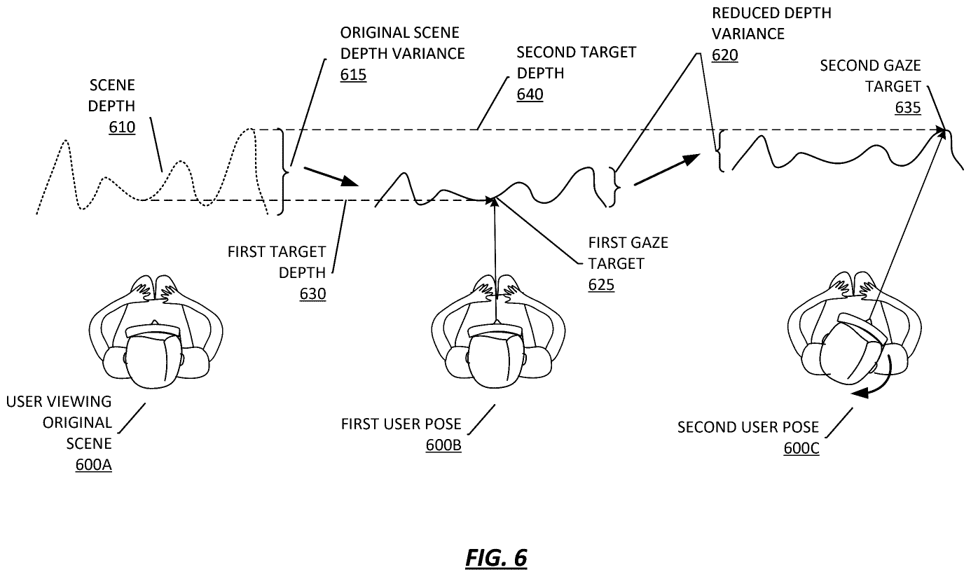

FIG. 6 shows an example diagram for dynamically adjusting a depth at which the compressed scene geometry is rendered. In particular, a same reduced depth variance is used, but the rendering depth at which the adjusted scene depth is used is based on a gaze target and an original depth of the gaze target. For example, as described above with respect to FIG. 2, a reduce scene depth variant may be determined at block 220 and used in conjunction with a gaze target regardless of a velocity of the motion.

In particular, FIG. 6 shows a representation of a user viewing an original scene 600A with a scene depth 610 having an original scene depth variance 615. For purpose of this example, the setup of the user viewing the original scene 600A is shown without applying an adjusted scene depth. In some embodiments, however, the scene depth 610 will be compressed to obtain the reduced depth variance 620. The depth at which the adjusted scene depth is rendered is based on a current gaze target and an original depth of the current gaze target. For example, first user pose 600B shows a first gaze target 625. The depth at which the adjusted scene depth is rendered is based on the first target depth 630. Said another way, a gaze target is determined in the scene. The gaze target is used to perform a lookup from the original scene depth 610 of the original depth of the gaze target (such as first target depth 630). Then, the compressed scene depth is rendered such that the first gaze target is rendered at a depth corresponding to the depth of the first gaze target in the original scene depth 610.

The first user pose 600B can be compared to second user pose 600C, in which the user has turned her head to correspond to second gaze target 635. Although the adjusted scene depths maintains the same reduced depth variance 620 as with the first user pose 600B, the depth at which the adjusted scene depth is rendered is changed in accordance with the updated gaze target. That is, second user pose 600C results in the second gaze target 635. Second target depth 640 is identified from a depth of the second gaze target in the original scene depth, then the compressed scene depth is rendered such that the second gaze target 635 is rendered at a depth consistent with the depth of the gaze target in the original scene depth 610. Thus, the artifacts are reduced due to the compressed depth, but the depth of a gaze target is presented consistently with the original scene depth.

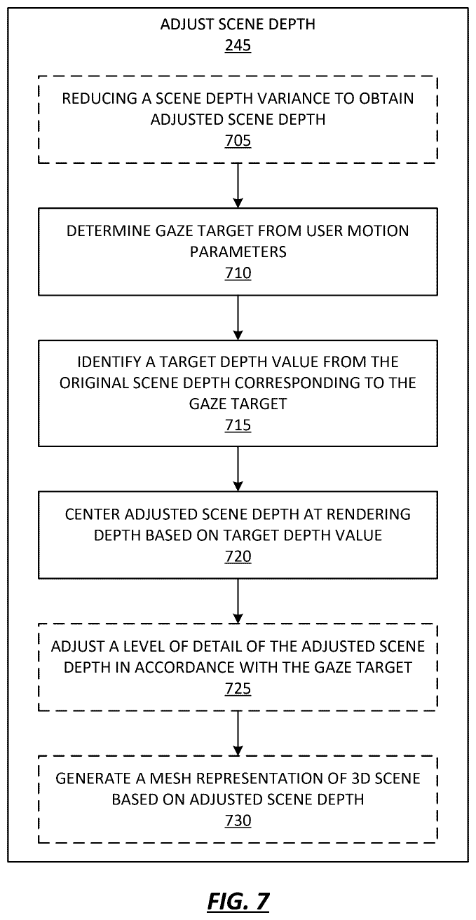

FIG. 7 shows a flowchart of an example technique for adjusting scene depth, in accordance with one or more embodiments. For purposes of explanation, the following steps will be described in the context of FIG. 6. However, it should be understood that the various actions may be taken by alternate components. In addition, the various actions may be performed in a different order. Further, some actions may be performed simultaneously, and some may not be required, or others may be added, according to various embodiments.

The flow chart begins at block 705, where, optionally, a scene depth variance is reduced to obtain an adjusted scene depth. For example, as shown in FIG. 6, the original scene depth 610 may be compressed to a reduced depth variance. The reduced depth variance may correspond to a set of adjusted depth values relative to different portions of the scene. That is, the adjusted scene depth may correspond to relative depth of the scene, but the depth at which the scene depth is rendered will vary. The amount of compression applied to the scene depth may be a predefined compression value. Additionally, or alternatively, an amount of compression applied to the scene depth may vary based on characteristics of the scene, the viewer, the device, or the like.

The flowchart proceeds to block 710, where a gaze target is determined from the user motion parameters. The gaze target may be determined, for example, from eye tracking data collected by the device. For example, a gaze vector may be projected into the scene based on a pupil location where other positional information for the eyes. Additionally, or alternatively, the gaze target may be determined based on points of interest detected or identified in the scene.

The flowchart proceeds to block 715, where a target depth value is identified in the original scene depth corresponding to the gaze target. Referring back to FIG. 6, when a user is gazing towards first gaze target 625, the first target depth 630 is obtained based on a corresponding point of the first gaze target in the original scene depth 610. Similarly, when second user posed 600C gazes towards second gaze target 635, the second target depth is determined based on an original depth for the second gaze target 635 in the original scene depth 610.

The flowchart proceeds to block 720, where the adjusted scene depth is centered at a rendering depth based on the target depth value. That is, whereas the adjusted scene depth obtained at block 705 that includes a set of relative depth values among different parts of the scene, at block 720, a rendering depth for the relative depth values is determined. Thus, depth values for the adjusted seam depth will be determined such that the depth of the gaze target is consistent between the original scene depth and the adjusted scene depth.

Optionally, at block 725, a level of detail is adjusted in the scene in the adjusted scene depth in accordance with the gaze target. That is, whereas the adjusted scene depth includes a geometry of the 3D scene, in order to improve latency and/or reduce artifacts, a level of detail may be reduced further away from the gaze target. For example, portions of the scene away from the gaze target may not be visible, or may be minimally visible to the user through their peripheral vision. Accordingly, compute may be saved by reducing the detail of the 3D scene to be rendered in those portions of the scene.

The flow chart concludes with optional step 730, where a mesh representation of the 3D scene is generated based on the adjusted scene depth. For example, a geometry of the scene can be used for rendering the 3D scene by generating a geometric representation of the scene onto which the image data is to be projected. The mesh representation may be a geometric representation which optionally reduces the level of detail of the geometry away from the gaze target, as described above with respect to block 725. The mesh representation may be any kind of geometric representation of the scene. For example, a point cloud or other geometric representation may similarly be used based on the adjusted scene depth.

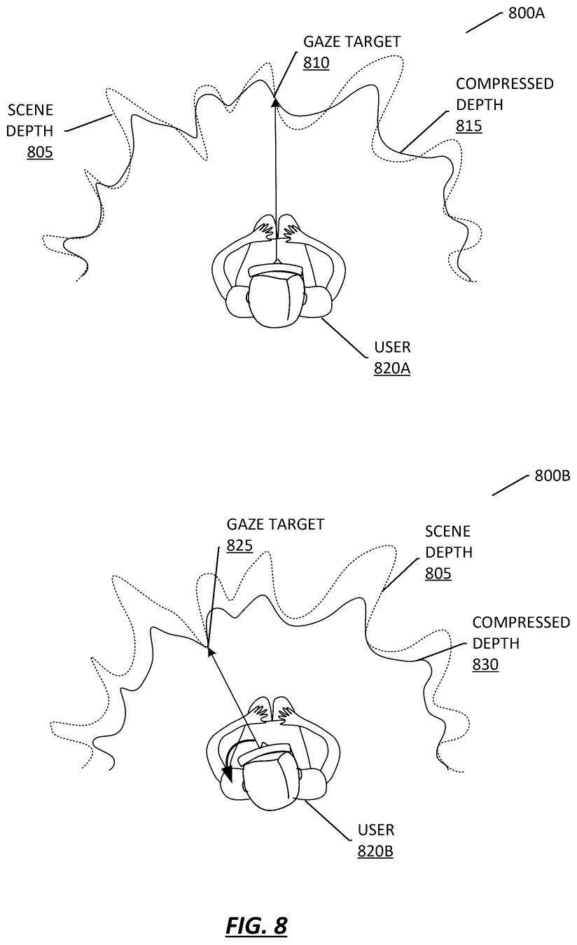

FIG. 8 shows another example view of how the compressed scene depth is dynamically rendered based on a gaze target. In particular, in diagram 800A, user 820A is viewing a gaze target 810. The scene is associated with an original scene depth 805. A compressed depth 815 may be generated to have a reduced depth variance from the scene depth. The compressed depth 815 is rendered at a radius such that gaze target 810 is consistent between the original scene depth 805 and the compressed depth 815.

Similarly, in diagram 800B, the user 820B adjusts their gaze to view gaze target 825. Compressed depth 830 may have a same reduced depth variance as compressed depth 815, but may be rendered at a different radius around the user. Namely, the compressed depth 830 is rendered at a radius such that gaze target 825 is consistent between the original scene depth 805 and the compressed depth 830.

### Scene Rendering

FIG. 9 shows a flowchart of an example technique for rendering the scene based on image data and adjusted scene depth, in accordance with one or more embodiments. In particular, the flowchart shows an example technique for generating a stereo frame pair using the adjusted depth data as described above with respect to block 250 of FIG. 2. For purposes of explanation, the following steps will be described in the context of particular components. However, it should be understood that the various actions may be taken by alternate components. In addition, the various actions may be performed in a different order. Further, some actions may be performed simultaneously, and some may not be required, or others may be added, according to various embodiments.

The flowchart begins at block 905, where image data is projected from lens space using camera calibration parameters and a disparity map. As described above, the camera calibration parameters may include intrinsic properties like focal length, principal point, and lens distortion coefficients. The disparity map represents a horizontal shift between the left and right images, and can be used with the camera calibration parameters to calculate depth. Each pixel in the resulting depth map corresponds to a depth value, indicating the distance of that point from the camera.

The flow chart proceeds to block 910, where the projected image data is reprojected onto a 2D display space using a view projection matrix and the adjusted depth data. According to one or more embodiments, the view projection matrix combines the view from the position and orientation of the camera with the projection transformation, mapping the 3D points to 2D screen coordinates.

Because the playback device may use stereo images for presenting the immersive content, reprojection may need to be performed for each eye. As shown at block 915, reprojecting the projected image data may include reprojecting the projected image based on a left eye reference to obtain a left eye image. Similarly, as shown at block 920, reprojecting the projected image data may include reprojecting the projected image based on a right eye reference to obtain a right eye image. For example, the view projection matrix for the left eye may differ from the view projection matrix for the right eye due to the different viewpoints and displays for each eye.

The flow chart proceeds to block 925, where, optionally, background image data is identified. For example, an analysis may be performed on the image data to determine which portions of the view are foreground and which are background. This may be determined, for example, based on the depth data for the image, saliency detection, or some combination thereof. In some embodiments, edge detection is performed to identify a boundary of foreground features.

The flow chart concludes with optional block 930, where background image data is warped to project onto the unavailable pixels from user motion. That is, where a portion of image data is unavailable for the scene due to the head pose, the unavailable pixels can be filled by warping the background image data towards the foreground image data. In some embodiments, an occlusion filter is used such that holes are filled by stretching background pixels toward foreground objects. Alternatively, other hole filling techniques can be used. For example, a temporal filling technique may be used such that the hole is filled with image data from a prior frame. As another example, the missing data may be sampled from another camera or source having the image data.

FIG. 10 is a data flow diagram for rendering a 3D scene, in accordance with one or more embodiments. The diagram outlines the processes involved in receiving 3D media from a content platform 1005, and rendering 3D scene data at a local device 1010. The various processes are described as being performed by particular components. However, it should be understood that the various processes may be performed by additional or alternative components, according to one or more embodiments.

The content platform 1005 may be hosted across one or more network devices, and may be configured to host immersive content. For example, content platform 1005 may include 3D media store 1015, which may host immersive media content and related data for playback at a playback device, such as local device 1010. According to some embodiments, the content platform 1005 may provide 3D scene data 1020, which may include image data and/or depth data. Content platform 1005 may also provide calibration data 1025 specific to the cameras capturing the 3D scene data 1020, and disparity data 1030 for the 3D scene data 1020. In some embodiments, the content platform 1005 may provide the various data for the 3D scene in a single transmission or in multiple transmissions.

The local device 1010 may be a playback device on which immersive media can be presented. In some embodiments, local device 1010 may be a head mounted device or other wearable device. The local device 1010 performs sensor data collection 1035. For example, local device 1010 may collect sensor data related to a user from one or more sensors on or in the local device 1010, and/or one or more sensors on a separate device communicably coupled to the local device 1010. Sensor data may include data related to head motion and/or gaze tracking. For example, the position or direction of a user's head, as well as velocity information for the motion of the head may be determined from sensor data such as gyroscopes, accelerometers, magnetometers, and the like. Gaze tracking data may be obtained from user-facing sensors that collect information about the user's eye orientation.

From the sensor data, the local device can perform gaze determination 1040 using gaze tracking data from the sensor data and the 3D scene data. That is, based on the head motion data and/or gaze tracking data, a determination can be made as to a direction the user is looking in the form of a gaze vector. The gaze vector can then be projected into the scene to determine a point of intersection with the scene depth data. The position in the 3D scene data at which the intersection occurs may be determined to be the gaze target 1045.

The local device 1010 may also use the sensor data from sensor data collection 1035 to perform a motion determination 1050 from which motion parameters 1055 can be determined. The motion determination may use the location and/or motion information for the head and/or eyes from the sensor data to determine a rate of motion of the user. For example, a rate of motion of the user's head may be determined, and/or a rate of motion of the user's gaze may be determined.

The local device 1010 can ingest the gaze target 1045 and the motion parameters 1055, as well as calibration data 1025 into a reprojection renderer 1065. In some embodiments, the disparity data 1030 may be optimized using disparity optimization 1060 prior to being used by the reprojection renderer. In particular, disparity optimization may include resolving the ambiguity of depth edges, such as the boundaries of foreground objects. Additional processing may be performed to avoid missing image data in the final image. For example, a nearest foreground edge filter may be used to avoid openings in the reprojection mesh. This may include gradually transitioning background depth toward the foreground depth such that the foreground objects maintain their appearance and visibility of distortions is minimized.

According to one or more embodiments, the reprojection renderer 1065 may include a GPU vertex and fragment shader. In some embodiments, the vertex shader inverts lens distortion using the camera intrinsics, and projects the image using the disparity map (or the optimized disparity map) from lens space to obtain a 3D image, then reprojects onto a 2D display for each eye. As a result, the resultant stereo frame pair 1075 is generated. The stereo frame pair 1075 may then be presented on a stereo display of the local device 1010 to provide an immersive experience to the user with reduced artifacts.

### Rendering at Uniform Depth

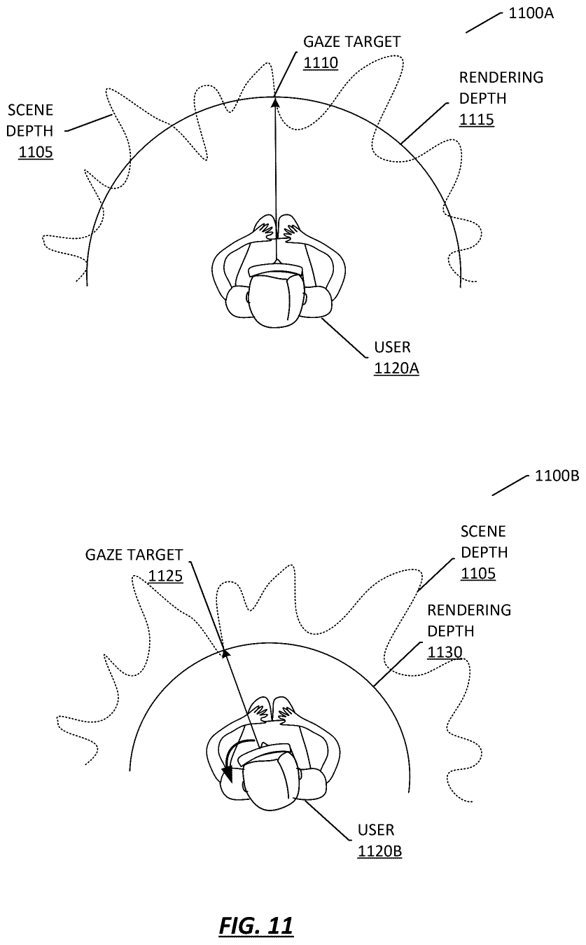

In some embodiments, the depth map may simply be used to determine a target depth and not used for a final rendering. FIG. 11 provides an alternate example diagram for dynamically modifying a scene depth based on a gaze target, in accordance with one or more embodiments. In some embodiments, the depth information for the immersive content can be used to determine a rendering depth, but the immersive content may be rendered uniformly at the rendering depth using the image data but not the scene depth.

In particular, in diagram 1100A, user 1120A is viewing a gaze target 1110. The scene is associated with an original scene depth 1105. Rather than compressing the scene depth, the depth of the gaze target 1110 can be referenced from the scene depth 1105 and use as a rendering depth 1115 onto which the corresponding image data is projected. Accordingly, the depth of the scene at the gaze target 1110 is consistent with the captured depth, and the depth of other components of the scene are projected onto a plane at the rendering depth 1115. The depth of the gaze target 1110 is therefore consistent between the original scene depth 1105 and the rendering depth 1115.

Similarly, in diagram 1100B, the user 1120B adjusts their gaze to view gaze target 1125. Thus, the depth of the gaze target 1125 can be referenced from the scene depth 1105 and used as a rendering depth 1130 onto which the corresponding image data is projected. Accordingly, the depth of the scene at the gaze target 1125 is consistent with the captured depth, and the depth of other components of the scene are projected onto a plane at the rendering depth 1130. The depth of the gaze target 1125 is therefore consistent between the original scene depth 1105 and the rendering depth 1130.

Because the depth of the gaze target 1110 is further away from the user than the gaze target 1125, the radius of the rendering plane is greater when the user is directed at gaze target 1110 than when the user is directed at gaze target 1125. Said another way, a radius of the rendering depth is dynamically modified as a user's gaze changes such that the gaze target appears at a depth corresponding to the depth of the gaze target in the original captured scene.

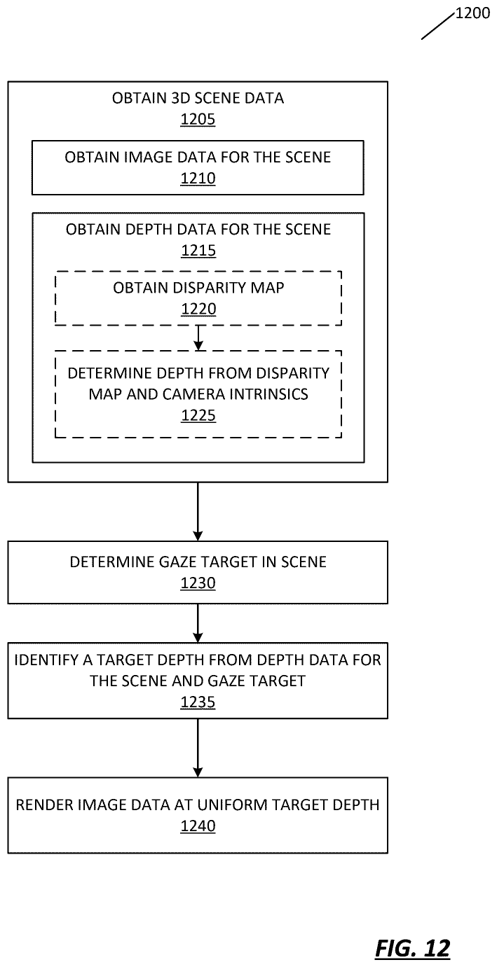

FIG. 12 depicts a flowchart of a technique for adjusting a uniform scene depth based on gaze, in accordance with one or more embodiments. For purposes of explanation, the following steps will be described in the context of particular components. However, it should be understood that the various actions may be taken by alternate components. In addition, the various actions may be performed in a different order. Further, some actions may be performed simultaneously, and some may not be required, or others may be added, according to various embodiments.

The flowchart 1200 begins at block 1205, obtaining scene data for a 3D scene. The 3D scene data may be obtained from a network device or remote service, such as a media distribution platform, or may be stored locally on a playback device. According to one or more embodiments, obtaining scene data may include obtaining image data for the scene at block 1210, and obtaining depth data for the scene, as shown at block 1215. According to some embodiments, the image data and/or depth data may be obtained from one or more remote devices over a network. The image data and/or depth data may be obtained locally at a device configured to present 3D content, such as a head mounted device or other wearable or mobile device.

According to some embodiments, the depth data for the scene obtained at block 1215 may be determined from disparity in the stereo images. The disparity map may be generated by comparing the left and right images of the stereo images for the 3D media item as captured by the stereo camera. Thus, an optional step 1220, obtaining depth data for the scene may include obtaining a disparity map for the 3D scene data. The disparity map is generated by comparing the left and right images captured by the stereo cameras. Each value in the disparity map represents the horizontal shift (disparity) between corresponding points in the left and right images, where a larger value indicates a closer object to the camera. At block 1225, depth of the scene is determined from the disparity map and camera intrinsics. In particular, calibration parameters specific to the camera that captured the scene are used to determine depth. This may include, for example, focal length, principal point, lens distortion coefficients, and the like. The camera calibration parameters may be used to correct for distortions in the captured images so that the depth is accurately mapped. Depth is determined for the scene using a combination of the focal length of the camera, baseline distance of the two cameras, and the disparity value. In some embodiments, a depth map can be constructed from the depth values, and/or a geometry of the scene can be generated, such as a mesh or a point cloud representing a geometry of the scene.

The flowchart 1200 proceeds to block 1235, where a gaze target is determined in a scene. In some embodiments, the gaze target maybe determined based on user motion parameters related to head movement and/or gaze direction. In some embodiments, the user motion parameters may be determined based on sensor data collected from the local device. According to embodiments, gaze tracking data may be obtained from one or more user-facing sensors of an HMD configured to collect information about a user's eye. For example, an orientation of the eyes may be determined based on sensor data capturing the eyes viewing the HMD. The orientation of the eyes may be used to determine characteristics regarding the gaze. In some embodiments, a gaze vector may be projected out from the eyes into the immersive media to determine a gaze target.

At block 1235, a target depth is identified from the depth data for the scene and the gaze target. According to one or more embodiments, the target depth is determined by referencing a target depth for the gaze target in the depth data obtained at block 1215. That is, a corresponding part of the depth map may be referenced to identify an original depth for the gaze target.

The flowchart 1200 concludes at block 1240, where the image data is rendered at the target depth. In one or more embodiments, the image data is rendered at the depth in a uniform manner, such that other depth values from the depth map are ignored. Accordingly, although the playback device may receive or determine the depth information, the playback device only uses the depth to determine a rendering plane, and does not use a geometry of the environment to render the 3D scene data.

### Example System Diagrams

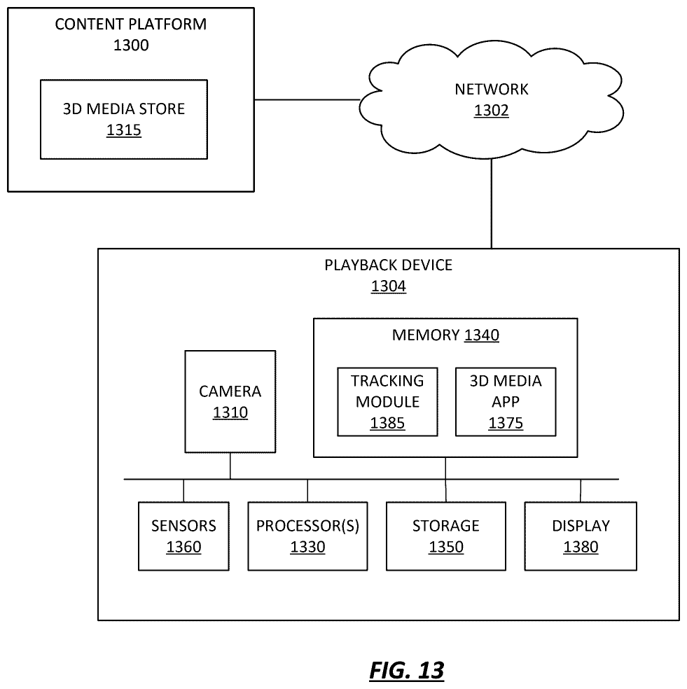

FIG. 13 depicts an example system configured to present immersive content, in accordance with one or more embodiments. Specifically, FIG. 13 depicts a playback device 1304 in the form of a computer system having media playback capabilities. Playback device 1304 may be an electronic device, and/or may be part of a multifunctional device, such as a mobile phone, tablet computer, personal digital assistant, portable music/video player, wearable device, head-mounted system, projection-based system, base station, laptop computer, desktop computer, network device, or any other electronic system such as those described herein having the capability of presenting 3D image data with overlay content. Playback device 1304 may be connected to other devices across a network 1302 such as one or more network device(s) comprising content platform 1300. Illustrative networks include, but are not limited to, a local network such as a universal serial bus (USB) network, an organization's local area network, and a wide area network such as the Internet.

Content platform 1300 may be comprised in one or more electronic device, each including one or more processor(s), such as central processing units (CPUs), system-on-chip such as those found in mobile devices, and dedicated graphics processing units (GPUs). According to one or more embodiments, content platform 1300 may be configured to store data for three-dimensional content, such as 3D or immersive media data in 3D media store 1315. The 3D media store may include three-dimensional media data in the form of stereoscopic image frames and other components used to generate an immersive environment. In some embodiments, the content platform 1300 may provide the content in response to a request from the playback device 1304. In some embodiments, the content platform 1300 may additionally determine and/or provide depth information for the immersive content.

The playback device 1304 may allow a user to interact with extended reality (XR) environments, for example via display 1380. The playback device 1304 may include one or more processor(s) 1330. Processor(s) 1330 may include, central processing units (CPUs), a system-on-chip such as those found in mobile devices and include one or more dedicated graphics processing units (GPUs). Further, processor(s) 1330 may include multiple processors of the same or different type. The playback device 1304 may also include a memory, such as memory 1340. Each memory may include one or more different types of memory, which may be used for performing device functions in conjunction with one or more processors, such as processor(s) 1330. For example, each memory may include cache, ROM, RAM, or any kind of transitory or non-transitory computer-readable storage medium capable of storing computer-readable code. Each memory may store various programming modules for execution by processors, including tracking module 1385, which may be used to track user motion, such as location information, user pose and motion data, eye tracking data, and the like.

The memory 1340 may also store a 3D media app 1375, which may be used to request immersive media from the content platform 1300 and/or perform playback operations on immersive media stored locally. In some embodiments, the 3D media app 1375 may render the immersive media for display on display 1380 based on information from tracking module 1385. For example, the tracking module may collect user motion parameters based on sensor data from camera 1310 and/or sensors 1360, such as gaze direction, head pose, and the like. For example, the sensors 1360 may include one or more positional sensors, such as an accelerometer, gyroscope, inertial motion unit (IMU), or the like. Camera 1310 may include a user-facing camera which is configured to track eye tracking data.

The playback device 1304 may also include storage, such as storage 1350. Each storage may include one more non-transitory computer-readable mediums, including, for example, magnetic disks (fixed, floppy, and removable) and tape, optical media such as CD-ROMs and digital video disks (DVDs), and semiconductor memory devices such as Electrically Programmable Read-Only Memory (EPROM) and Electrically Erasable Programmable Read-Only Memory (EEPROM).

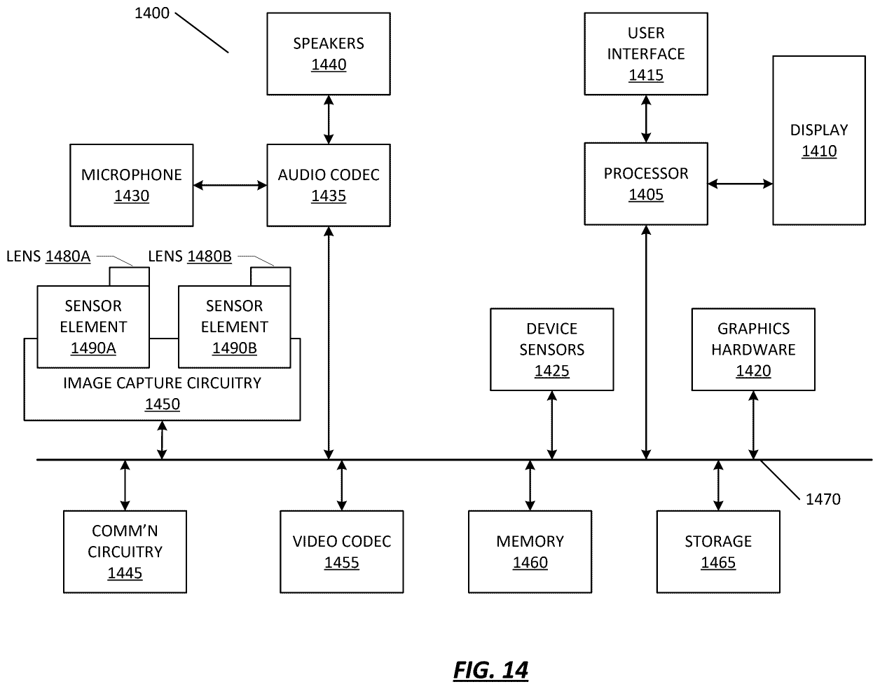

FIG. 14 depicts a system diagram of an electronic device on which embodiments described herein may be performed. The electronic device may be a multifunctional electronic device or may have some or all of the components of a multifunctional electronic device described herein. Multifunction electronic device 1400 may include some combination of processor 1405, display 1410, user interface 1415, graphics hardware 1420, device sensors 1425 (e.g., proximity sensor/ambient light sensor, accelerometer and/or gyroscope), microphone 1430, audio codec 1435, speaker(s) 1440, communications circuitry 1445, digital image capture circuitry 1450 (e.g., including camera system), memory 1460, storage device 1465, and communications bus 1470. Multifunction electronic device 1400 may be, for example, a mobile telephone, personal music player, wearable device, tablet computer, or the like.

Processor 1405 may execute instructions necessary to carry out or control the operation of many functions performed by device 1400. Processor 1405 may, for instance, drive display 1410 and receive user input from user interface 1415. User interface 1415 may allow a user to interact with device 1400. For example, user interface 1415 can take a variety of forms, such as a button, keypad, dial, click wheel, keyboard, display screen, touch screen, and the like. Processor 1405 may also, for example, be a system-on-chip, such as those found in mobile devices, and include a dedicated GPU. Processor 1405 may be based on reduced instruction-set computer (RISC) or complex instruction-set computer (CISC) architectures or any other suitable architecture and may include one or more processing cores. Graphics hardware 1420 may be special purpose computational hardware for processing graphics and/or assisting processor 1405 to process graphics information. In one embodiment, graphics hardware 1420 may include a programmable GPU.

Image capture circuitry 1450 may include one or more lens assemblies, such as lens 1480A and 1480B. The lens assembly may have a combination of various characteristics, such as differing focal length and the like. For example, lens assembly 1480A may have a short focal length relative to the focal length of lens assembly 1480B. Each lens assembly may have a separate associated sensor element 1490A and 1490B. Alternatively, two or more lens assemblies may share a common sensor element. Image capture circuitry 1450 may capture still images, video images, enhanced images, and the like. Output from image capture circuitry 1450 may be processed, at least in part, by video codec(s) 1455, processor 1405, graphics hardware 1420, and/or a dedicated image processing unit or pipeline incorporated within communications circuitry 1445. Images so captured may be stored in memory 1460 and/or storage 1465.

Memory 1460 may include one or more different types of media used by processor 1405 and graphics hardware 1420 to perform device functions. For example, memory 1460 may include memory cache, read-only memory (ROM), and/or random-access memory (RAM). Storage 1465 may store media (e.g., audio, image, and video files), computer program instructions or software, preference information, device profile information, and any other suitable data. Storage 1465 may include one more non-transitory computer-readable storage mediums, including, for example, magnetic disks (fixed, floppy, and removable) and tape, optical media such as CD-ROMs and DVDs, and semiconductor memory devices such as EPROM and EEPROM. Memory 1460 and storage 1465 may be used to tangibly retain computer program instructions or computer-readable code organized into one or more modules and written in any desired computer programming language. When executed by, for example, processor 1405, such computer program code may implement one or more of the methods described herein.

There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display device may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

It is to be understood that the above description is intended to be illustrative and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIGS. 2, 4-5, 7, and 9-11, or the arrangement of elements shown in FIGS. 1, 3, 6, 8, and 12-14 should not be construed as limiting the scope of the disclosed subject matter. The scope of the invention, therefore, should be determined with reference to the appended claims, along with the full scope of equivalents to which such claims are entitled. In the appended claims, the terms “including” and “in which” are used as the plain English equivalents of the respective terms “comprising” and “wherein.”

1. A method comprising:
obtaining scene data for a 3D scene comprising image data and depth data;
obtaining user motion parameters;
in response to the user motion parameters satisfying a treatment threshold, adjusting the depth data to obtain adjusted depth data in accordance with the user motion parameters; and
rendering an image of the 3D scene based on the image data and the adjusted depth data.

2. The method of claim 1, wherein the user motion parameters are based on head rotation values.

3. The method of claim 2, wherein the user motion parameters are further based on eye translation values arising from the head rotation values.

4. The method of claim 1, wherein the scene data comprises an RGBD image.

5. The method of claim 1, wherein rendering the image of the 3D scene comprises rendering a left eye image and a right eye image based on the adjusted depth data.

6. The method of claim 5, wherein the depth data is based on disparity of the image data and camera intrinsics of a camera from which the image data was captured.

7. The method of claim 1, wherein obtaining the scene data comprises obtaining a disparity map for a first frame of the scene data and camera calibration parameters, and
wherein rendering the image of the 3D scene comprises:
projecting the image data of the first frame from lens space using the camera calibration parameters and the disparity map; and
re-projecting the projected image data onto a 2D display space using a view projection matrix and the adjusted depth data.

8. A non-transitory computer readable medium comprising computer readable code executable by one or more processors to:
obtain scene data for a 3D scene comprising image data and depth data;
obtain user motion parameters;
in response to the user motion parameters satisfying a treatment threshold, adjust the depth data to obtain adjusted depth data in accordance with the user motion parameters; and
render an image of the 3D scene based on the image data and the adjusted depth data.

9. The non-transitory computer readable medium of claim 8, wherein the user motion parameters are based on head rotation values.

10. The non-transitory computer readable medium of claim 9, wherein the user motion parameters are further based on eye translation values arising from the head rotation values.

11. The non-transitory computer readable medium of claim 8, wherein the scene data comprises an RGBD image.

12. The non-transitory computer readable medium of claim 8, wherein the computer readable code to render the image of the 3D scene comprises computer readable code to render a left eye image and a right eye image based on the adjusted depth data.

13. The non-transitory computer readable medium of claim 12, wherein the depth data is based on disparity of the image data and camera intrinsics of a camera from which the image data was captured.

14. The non-transitory computer readable medium of claim 8, wherein the computer readable code to obtain the scene data comprises computer readable code to:
obtain a disparity map for a first frame of the scene data and camera calibration parameters, and
wherein the computer readable code to render the image of the 3D scene comprises computer readable code to:
project the image data of the first frame from lens space using the camera calibration parameters and the disparity map; and
re-project the projected image data onto a 2D display space using a view projection matrix and the adjusted depth data.

15. The non-transitory computer readable medium of claim 14, wherein the computer readable code to re-project the projected image comprises computer readable code to:
re-project the projected image based on a left eye reference; and
re-project the projected image based on a right eye reference.

16. A system comprising:
one or more processors; and
one or more computer readable media comprising computer readable code executable by the one or more processors to:
obtain scene data for a 3D scene comprising image data and depth data;
obtain user motion parameters;
in response to the user motion parameters satisfying a treatment threshold, adjust the depth data to obtain adjusted depth data in accordance with the user motion parameters; and
render an image of the 3D scene based on the image data and the adjusted depth data.

17. The system of claim 16, wherein the user motion parameters are based on head rotation values.

18. The system of claim 17, wherein the user motion parameters are further based on eye translation values arising from the head rotation values.

19. The system of claim 16, wherein the scene data comprises an RGBD image.

20. The system of claim 16, wherein the computer readable code to render the image of the 3D scene comprises computer readable code to render a left eye image and a right eye image based on the adjusted depth data.
